(19) United States
(12) Patent Application Publication
(10) Pub. No.: US 2025/0329980 A1
(43) Pub. Date: Oct. 23, 2025

(54) AN OPTICAL SYSTEM

(71) Applicant: Leonardo UK Ltd, London (GB)

(72) Inventors: John BARR, London (GB); Stephen BEECHER, London (GB); Elizabeth MCDOUGALL, London (GB); Dan THORNE, London (GB)

(73) Assignee: Leonardo UK Ltd, London (GB)

(21) Appl. No.: 18/869,099

(22) PCT Filed: May 30, 2023
(86) PCT No.: PCT/EP2023/064401

§ 371 Date: Nov. 25, 2024

(30) Foreign Application Priority Data
May 27, 2022 (GB) 2207835.6

(51) Int. Cl. H01S 3/08; H01S 3/00; H01S 3/0941; H01S 3/23

(52) U.S. Cl. CPC H01S 3/08095; H01S 3/0071; H01S 3/08059; H01S 3/0941; H01S 3/2333

(57) ABSTRACT

An optical amplifier system as disclosed includes a gain medium and a pump mechanism configured to amplify first and second optical beams when they pass through the gain medium. The first and second beams, which have the same wavelength, take different paths through the gain medium such that the beams are neither parallel nor coaxial when they exit and/or enter through a first side of the gain medium.

A prism having a facet positioned on the first side of the gain medium is in the path of both beams. The facet is orientated to cause total internal refection of the one of the beams within the prism but be transmissive to the other, so that paths of the two beams can be altered relative to one another allowing the beams to be either brought closer together or separated out.

The present invention relates to an optical system. In one aspect the invention relates to an optical amplifier particularly but not exclusively a multipass optical amplifier.

In laser systems where high gain of an optical beam is required, one solution is to provide multiple amplifiers that amplify the optical beam in sequence. An alternative solution is to employ a multipass amplifier in which the optical beam is configured to pass through the same gain medium multiple times. The latter solution allows for a reduction in the number of components, size and weight of the laser system compared with using multiple amplifiers.

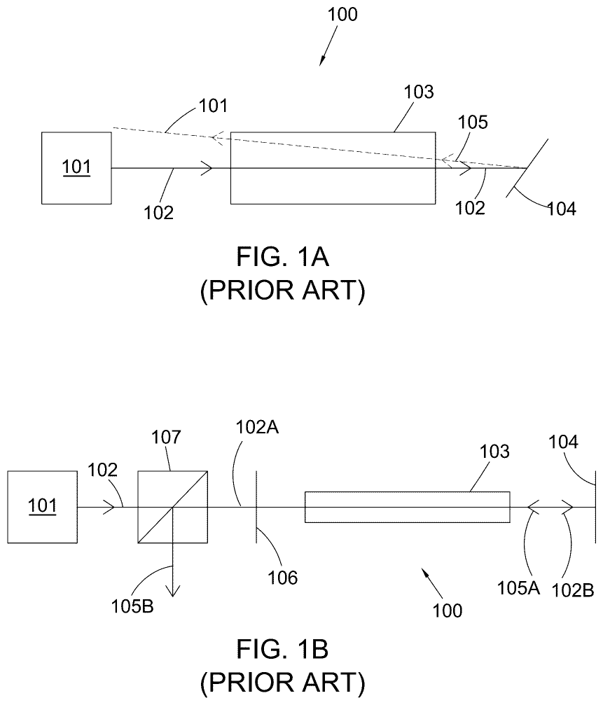

FIG. 1A, illustrates a simple arrangement of a prior art multipass amplifier 100. A beam source 101 is arranged to direct a beam 102 through a gain medium 103. A mirror arrangement 104 on the output side of the gain medium 103 is arranged to reflect the amplified beam 102 back into the medium 103 at an angle from the beam 102 such that the reflected beam 105 takes a different path back through the medium 103 to the input beam 102. This solution has a number of problems. Firstly, is it necessary to space the beam source 101 at a relatively large distance from the gain medium 103 to provide sufficient space to accommodate the next component of the optical assembly that is to receive the reflected beam 105 once outputted from the gain medium 103. Secondly, if multiple mirrors are needed to redirect the input beam 102 back into the gain medium 103, they also need to be spaced a relatively large distance apart and thus also spaced a relatively large distance from the gain medium 103 to provide the necessary separation in beam angle between the input and reflected beams 102,105. This results in an optical assembly that is physically long. A further issue is that the gain medium 103 is not used efficiently meaning a bigger pump source is required which also increases the heat load within the total amplifying medium.

An alternative arrangement is illustrated in FIG. 1B. The input beam 102 passes through a polarizer 107 (that is also being used as a beam splitter) to provide a linearly polarised input beam 102A, and then a N/4 waveplate 106 which outputs a circularly polarised input beam 102B that enters the gain medium 103. The mirror 104 is arranged so that the reflected beam 105 follows the same path back through gain medium 103 as the input beam 102B. As a consequence of reflection, the reflected beam 105 has a circular polarisation of opposite hand to the circularly polarised input beam 102B. The λ/4 waveplate 106 converts the reflected beam 105 to a linearly polarised reflected beam 105A with a polarisation that is orthogonal to the linearly polarised input beam 102A. The polariser 107 separates the amplified output beam 105B from the input beam 102A. This arrangement allows for a more compact design compared with that of FIG. 1A; however, overtime the polariser 106 tends to leak amplified light back towards the beam source 101 which can damage or disrupt the beam source 101.

Kane et al, 62-dB-Gain Multiple-Pass Slab Geometry Nd: YAG Amplifier; Optics Letters, 11, Issue 4 216-218 1986, illustrates apparatus for multi-passing which comprises an array of mirrors arranged to circulate the beam through the gain medium such that the beam travels through the gain medium in the same direction each time. This design is relatively large compared with that of FIGS. 1A and 1B.

The present invention was conceived to provide an optical amplifier of a compact size that does not suffer the leaking issue of the design of FIG. 1B.

According to a first aspect of the invention there is provided an optical system comprising a gain medium having a first side and a second side, and a pump mechanism, which together are configured to amplify: first and second coherent optical beams that travel through the gain medium between the first and second sides, the first and second coherent optical beams travelling about different respective first and second paths that are neither parallel nor coaxial as the first and second optical beams pass into or out of the gain medium through the first side of the gain medium; an optical spacing means to alter the spacing between the first and second optical beams; characterised in that the optical spacing means comprises a prism having a facet; the prism being positioned about the first side of the gain medium so that the facet is in the first and second paths of the respective first and second coherent optical beams; the prism and facet configured so as to: be primarily transmissive to one of the first and second optical beams, and redirect the other of the first and second optical beams by way of total internal reflection.

Because the prism can be placed within the path of both first and second beams, it can be placed very close to, optionally physically against, the gain medium. The optical spacing means can be configured to increase the separation distance between of the beams enabling multiple optical components lying on the same side of the gain medium, e.g. a beam source and further optic, to be placed much closer to the gain medium, and thus allowing for a reduction in the length of the optical system.

Each beam may have associated with it, a respective:
first passage point where the beam enters the optical spacing means from the gain medium, or leaves the optical spacing means towards the gain medium; and
second passage point where the beam enters the optical spacing means on its way to the gain medium, or leaves the optical spacing means having already passed through the gain medium.

The optical spacing means is favourably configured such that the physical spacing between the second passage points is greater that the physical spacing between the first passage points and/or the angle of divergence between the first and second beams at the second passage points is greater than at the first passage points. The former is desirable, for example, where it is desired that the beams are parallel when passing through the second passage points.

Consequently, the invention provides advantage in both applications where the first and second beams are travelling in the same direction through the first surface of the gain medium as well as where the first and second optical beams travel in opposite directions through the first side of the gain medium. In one embodiment the invention is directed to a multipass optical amplifier. Nevertheless, the inventors realise that the invention may have broader application. For example:
to amplify two similar wavelength beams on a single pass through the gain medium and extract them after amplification;
in an optical amplifier where one of the first and second beams is used to optically pump a laser gain material; and
where one of the beams is used to excite a chemical species on a facet of the gain medium and the other beam is a consequence of the optical florescence resulting from the excited chemical.

In one arrangement, the optical spacing means may have a first side facing towards the gain medium, and a second side facing away from the gain medium; the optical spacing means arranged to cause the first and second beams to have substantially parallel paths as they pass through the second side of the optical spacing means. The provision of parallel paths may allow for further reduction in separation of multiple optical components lying on the same side of the gain medium.

The optical spacing means may comprise a second prism. The second prism is arranged in the path of whichever of the first and second beam passes through the facet to redirect said beam. The second prism may function to correct for refraction of the transmitted beam as a consequence of its transmission through the facet, e.g. such that it exits the optical spacing means on a path that is substantially parallel to the path it entered the optical spacing means.

The optical system may comprise a reflector on the first side of the gain medium, the reflector adapted to reflect the first beam after it has passed out of the optical spacer means, back towards the optical spacer means as the second beam; the optical spacer means adapted to direct the second beam received from the reflector back through the first side of the gain medium. The reflector may comprise, for example, a corner cube and/or image rotator.

This arrangement allows for the reflector to be positioned relatively close to the gain medium compared with the prior art embodiment of FIG. 1A.

The optical system including the gain medium may be arranged such that the first and second coherent optical beams pass into or out of the gain medium through the second side. Where so, the reflector may be arranged on a second side of the gain medium, to reflect the first optical beam after it has passed out of the second side of the gain medium back into the gain medium about the second path. In this arrangement the optical spacer means functions to increase the separation between the input beam (first beam) and amplified output beam (second beam).

The first and second paths through the gain medium, may be such that the first and second optical beams are neither parallel nor coaxial as they pass into or out of the second side of the gain medium. Where so, the optical system may comprise a further optical spacing means; the further optical spacing means arranged to receive the first beam outputted from the gain medium and to direct the first beam to the reflector, and to receive the second beam from the reflector and direct back into the gain medium.

The further optical spacing means may comprise a further prism having a further facet; the further prism and further facet adapted to be primarily transmissive to one of the first and second optical beams and redirect the other of the first and second optical beams by way of total internal reflection. This arrangement, with optical spacing means on both sides of the gain medium, allows for compaction of the optical system at both ends.

The laser gain medium may have a zig-zag slab geometry in order that the first and second paths through the gain medium are zig-zag paths.

The pump mechanism may comprise a laser diode pump.

The optical system may comprise a heat sink arranged directly against a third side of the gain medium to extract heat, by conductive cooling, from the gain medium through the third side; the third side extending between the first and second sides. The heat exchanger may be bonded or clamped to the gain medium and attached to a suitable cold plate. It is beneficial that the heat exchanger has a coefficient of thermal expansion that is similar to the material of the gain medium.

The pump mechanism may be adapted to inject pump radiation into the gain medium through a fourth side of the heat sink; the fourth side extending between the first and second sides.

For most if not all applications it is preferable that the facet of the prism is as transmissive as possible to one of the beams to minimise optical losses in that beam. As such the facet may be greater or equal to 90% optically transmissive to that beam.

The first and second optical beams maybe of the same optical wavelength.

The invention will now be described by way of example with reference to the following Figures in which:

FIG. 1A is a simplified schematic of a prior art multipass optical amplifier;

FIG. 1B is a simplified schematic of a variant prior art multipass optical amplifier; and

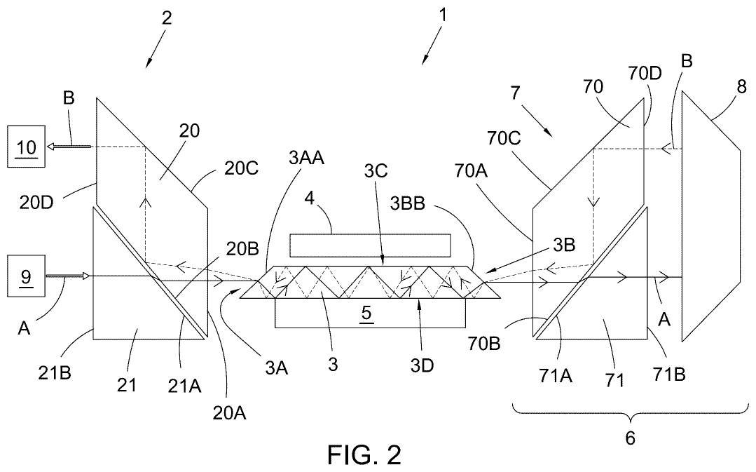

FIG. 2 is a simplified schematic of a multipass optical amplifier;

FIG. 2 illustrates a multipass optical amplifier 1. The amplifier 1 comprises a first beam spacer 2, a gain medium 3, a laser pump 4 to pump the gain medium 3, a heat sink 5 and a reflector assembly 6 comprised from a second beam spacer 7 and a reflector 8.

The gain medium 3 has a first side 3A, second side 3B, third side 3C and fourth side 3D. The first and second sides 3A 3B face opposite directions. Each of the third and fourth sides extend between the first and second sides 3A 3B, and face opposite directions to one another.

The gain medium 3 has a first face 3AA on the first side 3A, and a second face 3BB on the second side 3B. The first and second faces 3AA 3BB face opposite directions.

The first beam spacer 2 is arranged about the first side 3A of the gain medium 3. The reflector assembly 6 is arranged about the second side 3B of the gain medium 3.

The laser pump 4, which may comprise a laser diode pump, is adapted to inject pump radiation into the gain medium 3 through the third side 3C.

The heat sink 5 is arranged directly against the fourth side 3D of the gain medium 3 to extract heat from the gain medium 3 through the fourth side 3D. Consequently, both pump radiation into the gain medium 3 and heat extraction out of the gain medium 3 occur in directions orthogonal to the general direction of travel of the optical beams to be amplified through the gain medium 3. This arrangement minimises the thermal lensing within the gain material.

A coherent beam of light from a seed source 9, provides an outward beam that follows a first path A (solid line) through the first beam spacer 2 and into the gain medium 3 through the first face 3AA, passing through the gain medium 3 along a first zig-zag path. The amplified beam exits the gain medium 3 through the second face 3BB and is redirected back about a second path B (dashed line) as the return beam by the reflector assembly 6 into the gain medium 3 to be amplified a second time. Taking a different zig-zag path through the gain medium 3, the return beam exits the gain medium 3 through the first face 3AA before passing back through the first beam spacer 2. Upon exiting the first beam spacer 2, the second path B of the return beam is parallel to the first path A of the outward beam immediately before it enters the first beam spacer 2.

Importantly, the paths A and B of the respective outwards and return beams diverge (or at least are neither parallel nor coaxial) as they extend out of gain medium through the first and second faces 3AA 3BB.

The seed source 9 comprises a laser oscillator and optionally one or more further optical components, e.g. reflectors, lens, waveplates and polarizers to direct and/or modify the beam.

The first beam spacer 2 is comprised from a first optical prism 20 and a second optical prism 21. Each prism 20, 21 is comprised from a single integral piece of material that is highly transparent, e.g. greater than 90%, to the wavelength of the outward and return beams. The first and second prisms are made from substantially identical materials.

The first prism 20 defines a first facet 20A, a second facet 20B, a third fact 20C and a fourth facet 20D. The first facet 20A has an external surface facing towards the gain medium 3. The fourth facet 20D extends parallel to the first facet 20A with an external surface facing in a direction opposite the first facet 20A, i.e. away from the gain medium 3.

The second prism 21 comprises a first facet 21A and a second facet 21B. The first facet 21A has an external surface that faces towards and extends parallel with the second facet 20B of the first prism 20. The second facet 21B of the second prism 21 faces a direction opposite the first facet 21A and is parallel with the first and fourth facets 20A 20D of the first prism 20.

The first prism 20 is orientated such that the first facet 20A is perpendicular to the outward beam and the fourth facet 20D perpendicular to the return beam. The second prism 21 is orientated such that the second facet 21B is perpendicular to the path A of the outward beam.

The first prism 20 is configured such that the second facet 20B:
a) extends at an angle relative to the path A of the outward beam that allows the outward beam to pass through it, and into the first prism 20, with minimal reflection (transmission greater than 90%); and
b) extends at an angle relative to the path B of the return beam to cause total internal reflection (TIR) of the return beam.

The required angle of facet 20B will depend in part on the material of the prism.

The outward beam, travelling from the beam source 9, passes through the second facet 21B into the second prism 21 and out through the first facet 21A. The angle of facet 21A refracts the path A of the outward beam in a first direction as it exits the second prism 21. The refracted beam passes into the first prism 20 through the second facet 20B. By virtue of the parallel nature of facets 21A 20B, the refracted outward beam is refracted in the opposite direction by the same angle when it passes into the first prism 20. The outward beam passes out of the first prism 20 through the first facet 20A towards the gain medium 3.

The return beam, passing out of the first face 3AA of the gain medium 3, passes into the first prism 20 through first face 20A. By virtue of its angle of incidence with the first facet 20A, the return beam is diffracted. The diffracted beam passes through the first prism 20 until it reaches the second facet 20B where it undergoes TIR to be redirected towards the third facet 20C. At the third facet 20C the second beam undergoes TIR a further time so as to be redirected towards the fourth facet 20D. The second beam passes out of the first prism 20 through the fourth facet 20D. The first prism 20 is configured such the third facet 20C is angled relative to the return beam to redirect the return beam out of the first prism 20 about a path parallel with the outward beam entering the second prism 21.

The second beam spacer 7 is comprised from a third optical prism 70 and a fourth optical prism 71. Each prism 70, 71 is comprised from a single integral piece of material that is highly transparent, e.g. greater than 90%, to the wavelength of the first and second beams A B. The third and fourth prisms are made from substantially identical materials. The prisms 70, 71 of the second beams spacer 7 are arranged in mirror image to the prisms 20, 21 of the first beam spacer 2.

The third prism 70 defines a first facet 70A, a second facet 70B, a third fact 70C and a fourth facet 70D. The first facet 70A has an external surface facing towards the gain medium 3. The fourth facet 70D extends parallel to the first facet 70A with an external surface facing in a direction opposite the first facet 70A, i.e. away from the gain medium 3.

The fourth prism 71 comprises a first facet 71A and a second facet 71B. The first facet 71A has an external surface that faces towards and extends parallel with the second facet 70B of the third prism 70. The second facet 71B of the fourth prism 71 faces a direction opposite the first facet 71A and is parallel with the first and fourth facets 70A 70D of the third prism 70.

The third prism 70 is orientated such that the first facet 70A lies perpendicular to the path A of the outwards beam and the fourth facet 70D perpendicular to the path B of the return beam B. Similarly, the fourth prism 71 is orientated such that the second facet 71B lies perpendicular to the outward beam.

The third prism 70 is configured such that the second facet 70B:
a) extends at an angle relative to the path A of the outward beam that allows the outward beam to pass through it, and into the third prism 70, with minimal reflection (transmission greater than 90%); and
b) extends at an angle relative to the path B of the return beam to cause total internal reflection (TIR) of the return beam.

Again, the required angle of facet 70B will depend in part on the material of the third prism 70.

The outward beam passes out of the second face 3BB of the gain medium 3 towards the reflector assembly 6. The outward beam passes into the third prism 70 through the first facet 70A and out of the third prism 70 through the second facet 70B, being refracted as it exits the third prism 70. The refracted outward beam then passes into the fourth prism 71 through facet 71A. Because facets 70B and 71A are parallel, the path B of the outward beam is refracted back to a direction parallel to that before its incidence with the second facet 70B of the third prism 70. The outward beam passes out of the fourth prism 71 through second facet 71B and toward the reflector 8.

The outward beam is reflected by the reflector 8. The reflector 8, in this example, a corner cube, redirects the outward beam, as the return beam, back towards the gain medium 3, about a path parallel to the outward beam.

The return beam B passes into the third prism 70 through the fourth facet 70D and undergoes total internal reflection when incident on the third facet 70C being reflected towards the second facet 70B. The return beam B undergoes total internal reflection a second time when incident on the second facet 70B so as to be redirected out of the third prism 70 through the first facet 70A and into the gain medium 3.

By virtue of the afore described arrangement the physical spacing between the outward and return beams, as they pass through the respective second facet 21B and fourth facet 20D, is significantly greater than their spacing when they pass through the first facet 20A of the first prism 20. This allows both the seed source 9 and a further optical element 10 arranged to receive the return beam after exiting the first beam spacer 2, to be located closer to the gain medium 3 compared with an arrangement that relies solely on the divergence between the outward and return beams as a consequence of their non-parallel paths out of the gain medium 3.

For analogous reasons, the second beam spacer 7 allows the corner cube reflector 8 to be located closer to the gain medium 3.

The further optical element 10 may comprise, for example, any one or more of a: reflector, lens, waveplate and polarizer, to direct and/or modify the beam.

It will be appreciated that all surfaces of the prisms 20, 21,70, 71 of the first and second spacers 2, 7 may be slightly angled from ideal to minimise retro-reflection paths, as is well known to those skilled in the art.

The first optical spacer 2 may not comprise the second optical prism 21, if, for example, it is not required to make the paths of the outward and return beams parallel. The same is also true of the second optical spacer 7.

The configuration of the first optical prism 20, in particular the arrangement of the third and fourth facets 20C 20D may differ from that as described. For example, the fourth facet 20D may not be parallel to the first facet 20A; Alternatively, the first optical prism 20 may be adapted such that the return beam passes out of the third facet 20C, e.g. at an angle orthogonal to the outward beam, rather than through the fourth facet 20D.

The same applies to the second prism 21 mutandis mutatis.

The third facets 20C and 70C of the first and third prisms 20, 70 may be coated to reflect the return beam rather than arranging these facets to reflect the return beam through TIR.

An image rotation reflector may be used rather than a corner cube reflector. Either are preferred as they reflect light back about a path parallel path. This enables the dimensions of the amplifier to be kept more compact. Nevertheless, alternatively, other reflector means, for example, multiple, separate mirrors may be used instead.

In a further arrangement where the reflector assembly 6 comprises multiple separate mirrors rather than a single reflective element, the third prism 70 of the second optical spacer 7 may be adapted to receive the return beam, for example, through the third facet 70C rather than the fourth facet 70D.

In another variant, the reflector assembly 6 may be omitted and instead the gain medium 3 configured to reflect the outward beam off the second face 3BB, e.g. through TIR or by coating second face 3BB.

The first and second prisms may be manufactured from materials of different refractive indices to the third and fourth prisms. The first and second prisms may be from materials of different refractive indices. Similarly, though less preferred, the third and fourth prisms may be from materials of different refractive indices.

The zig-zag path slab gain medium of described embodiment is trapezoidal, however other prism forms may be used, for example where first side and second side are parallel. Where so the prisms 70, 71 of the second beams spacer 7 may not be arranged in mirror image to the prisms 20, 21 of the first beam spacer 2.

1-9. (canceled)

10. An optical system comprising:
a gain medium having a first side and a second side, and a pump mechanism, which together are configured to amplify first and second coherent optical beams when they travel through the gain medium between the first and second sides, the optical system being configured such that, when in use, the first and second coherent optical beams will travel about different respective first and second paths such that the first and second optical beams are neither parallel nor coaxial to one another as they pass into or out of the gain medium through the first side of the gain medium; and
an optical spacing means to alter a spacing between the first and second optical beams, wherein the optical spacing means includes:
a prism having a facet, the prism being positioned about the first side of the gain medium so that the facet is in the first and second paths of the respective first and second coherent optical beams, the prism and facet being configured such that by virtue of a different angle of incidence of the first beam with the facet compared with the second beam with the facet, the prism and facet are:
primarily transmissive to one of the first and second optical beams, and
redirect the other of the first and second optical beams by way of total internal reflection.

11. An optical system according to claim 10, wherein the optical spacing means has a first side facing towards the gain medium, and a second side facing away from the gain medium; the optical spacing means being arranged to cause the first and second beams to have paths that are substantially parallel paths to one another as they pass through the second side of the optical spacing means.

12. An optical system according to claim 10, configured and arranged such that the first and second optical beams will travel about their respective first and second paths in opposite directions through the first side of the gain medium.

13. An optical system according to claim 12, wherein:
the optical spacing means is positioned to receive the first beam after it has passed out of the first side of the gain medium; and
the optical system includes:
a reflector on the first side of the gain medium, the reflector being configured to reflect the first beam, after it has passed out of the optical spacer, back towards the optical spacing means as the second beam, the optical spacing means being adapted to direct the second beam received from the reflector back through the first side of the gain medium.

14. An optical system according to claim 12, configured and arranged such that the first beam will travel into the gain medium through the first side of the gain medium, and the optical system comprises:
a reflector means on a second side of the gain medium, the reflector means being adapted to reflect the first optical beam after it has passed out of the second side of the gain medium so as to cause it to travel, as the second optical beam, back through the gain medium about the second path.

15. An optical system according to claim 14, configured and arranged such that:
first and second paths through the gain medium are such that the first and second optical beams are neither parallel nor coaxial as they pass into or out of the second side of the gain medium; and
the reflector means includes:
a further optical spacing means and a further reflector, the reflector being adapted to reflect the first beam to provide the second beam, the further optical spacing means arranged to direct the first beam outputted from the gain medium towards the reflector, and to direct the second beam from the reflector back towards the gain medium, the further optical spacing means including a further prism having a further facet, the further prism and further facet being arranged in the first and second paths, and configured to:
be primarily transmissive to one of the first and second optical beams, and
redirect the other of the first and second optical beams by way of total internal reflection.

16. An optical system according to any claim 15, wherein the reflector, and/or further reflector, comprises:
a corner cube and/or image rotation reflector.

17. An optical system according to claim 10, wherein the gain medium has a zig-zag slab geometry.

18. An optical system according to claim 12, in combination with a multi-pass optical amplifier.

19. An optical system comprising:
a gain medium having a first side and a second side, and a pump mechanism, which together are configured to amplify first and second coherent optical beams when they travel through the gain medium between the first and second sides, the optical system being configured such that, when in use, the first and second coherent optical beams will travel about different respective first and second paths such that the first and second optical beams are neither parallel nor coaxial to one another as they pass into or out of the gain medium through the first side of the gain medium;
an optical spacing means to alter a spacing between the first and second optical beams, wherein the optical spacing means includes:
a prism having a facet, the prism being positioned about the first side of the gain medium so that the facet is in the first and second paths of the respective first and second coherent optical beams, the prism and facet being configured so as to:
be primarily transmissive to one of the first and second optical beams, and
redirect the other of the first and second optical beams by way of total internal reflection;
wherein the optical spacing means has a first side facing towards the gain medium, and a second side facing away from the gain medium, the optical spacing means being arranged to cause the first and second beams to have paths that are substantially parallel paths to one another as they pass through the second side of the optical spacing means.

20. An optical system comprising:
a gain medium having a first side and a second side, and a pump mechanism, which together are configured to amplify first and second coherent optical beams when they travel through the gain medium between the first and second sides, the optical system being configured such that, when in use, the first and second coherent optical beams will travel about different respective first and second paths such that the first and second optical beams are neither parallel nor coaxial to one another as they pass into or out of the gain medium through the first side of the gain medium;
an optical spacing means to alter a spacing between the first and second optical beams, wherein the optical spacing means includes:
a prism having a facet, the prism being positioned about the first side of the gain medium so that the facet is in the first and second paths of the respective first and second coherent optical beams; the prism and facet being configured so as to:
be primarily transmissive to one of the first and second optical beams, and
redirect the other of the first and second optical beams by way of total internal reflection;
wherein the first and second optical beams will travel about their respective first and second paths in opposite directions through the first side of the gain medium, with the first beam traveling into the gain medium through the first side of the gain medium; and the optical system includes:
a reflector means on a second side of the gain medium, the reflector means being configured to reflect the first optical beam after it has passed out of the second side of the gain medium so as to cause it to travel, as the second optical beam, back through the gain medium about the second path;
first and second paths being arranged through the gain medium such that the first and second optical beams are neither parallel nor coaxial as they pass into or out of the second side of the gain medium; and the reflector means includes:
a further optical spacing means and a further reflector, the reflector being adapted to reflect the first beam to provide the second beam, the further optical spacing means being arranged to direct the first beam outputted from the gain medium towards the reflector, and to direct the second beam from the reflector back towards the gain medium, with the further optical spacing means including:
a further prism having a further facet, the further prism and further facet being arranged in the first and second paths, and configured to:
be primarily transmissive to one of the first and second optical beams, and redirect the other of the first and second optical beams by way of total internal reflection.
